(19) United States
(12) Patent Application Publication
(10) Pub. No.: US 2023/0256765 A1
(43) Pub. Date: Aug. 17, 2023

(54) Outdoor-Durable Inkjet-Receptive Topcoat Formula and Article

(71) Applicant: Brady Worldwide, Inc., Milwaukee, WI (US)

(72) Inventors: Brian J. Fraleigh, New Berlin, WI (US); Timothy W. Shay, Milwaukee, WI (US); Brandon J. Adkins, Shorewood, WI (US); Richard C. Sonntag, Swarthmore, PA (US)

(21) Appl. No.: 18/015,018

(22) PCT Filed: Jul. 2, 2021
(86) PCT No.: PCT/US2021/040293

§ 371 Date: Jan. 6, 2023

Related U.S. Application Data
(60) Provisional application No. 63/050,499, filed on Jul. 10, 2020.

(51) Int. Cl. B41M 5/52; B41M 7/00; B41M 5/00

(52) U.S. Cl. CPC B41M 5/5254; B41M 5/5218; B41M 5/5227; B41M 7/0054; B41M 5/0047

(57) ABSTRACT

An ink-receptive composition for coating a substrate provides outstanding outdoor durability and color fade resistance. The ink-receptive composition includes a polymeric binder comprising an ethylene-based polymer, a pigment, a light stabilizer package comprising UV-absorber and a light stabilizer, and a surfactant. Notably, the ink-receptive composition is preferably free of mordant, if any mordant is present, then that mordant is present in an amount less than 5 weight percent of the composition and more preferably less than 3 weight percent of the composition, Related methods of manufacture, methods of printing, and articles coated with the composition are obtainable with this coating.

### CROSS-REFERENCE TO RELATED APPLICATIONS

This application claims the benefit of U.S. Provisional Patent Application No. 63/050,499 entitled “Outdoor-Durable Inkjet-Receptive Topcoat Formula and Article” filed on Jul. 10, 2020, which is incorporated by reference herein for all purposes.

### STATEMENT OF FEDERALLY SPONSORED RESEARCH OR DEVELOPMENT

Not applicable.

### BACKGROUND

This disclosure relates to compositions for coatings and, in particular, to compositions for inkjet-receptive coatings on articles that have improved outdoor durability and reduced color fade over time.

Signage intended for outdoor application (for example, billboards, labels, and so forth) is often produced using a wide-format inkjet press and protected from fade with a clear, polymeric overlaminate or clear coat lacquer. This protective barrier layer provides protection from ultraviolet (UV) exposure and water, both of which act to fade the printed image via degradation of the dye(s) or pigment(s) that comprise the image. Printers and dedicated manufacturers of specialty signage are well equipped to apply overlaminates or clear coatings during the production process. However, this is not the case for the typical end user of a small-format (10 inches or less in width) inkjet printer who is creating custom signage for outdoor applications.

For a small-format inkjet printer, clear coating and inline lamination are often not practical as the addition of these capabilities adds significant complexity and cost to what is intended to be a low-cost method of printing. Lamination as a secondary step after printing is a more economical option, but requires the end user to manually apply the overlaminate to every label. Proper application of the overlaminate is also then essential to achieve a defect and wrinkle-free appearance. For end users who regularly generate large quantities of small-format, custom labels, secondary overlamination is simply not a practical option.

In addition to outdoor durability, another consideration of importance to the printing industry is the density of the printed image (that is, the vibrancy and depth of color). A conventional method of achieving deep, vibrant coloration in inkjet-printed images through the use of cationic ink fixatives or mordants and is well-known to the art. Examples of mordants include, but are not limited to, polydiallylamine derivatives, mono or polyvalent metal salts, and hydroxyalkylated polyalkylenimines. The mordant serves to attract and “fix” the anionic dye or pigment components of the ink at or near the surface of the coating through electrostatic interaction. This localized concentration of dye and/or pigment results in a more vibrant image, with the added benefit of resilience to short-term water exposure. As an example, Miyamoto (U.S. Pat. No. 4,613,525) describes the use of water-soluble polydiallylamine derivatives, among others, to create coatings that, when printed with an inkjet recorder, yield brilliant and water-fast images. Lin and Shih further disclose in U.S. Pat. No. 6,153,288 the use of at least one of 1) a polydiallydimethylammonium compound, and 2) a copolymer of dimethylaminoethyl acrylate or methacrylate and at least one hydroxyl-lower organic acrylate or methacrylate, in a quantity of 5-50% by dry weight of the inkjet-receptive coating composition.

### SUMMARY

The conventional incorporation of mordants into a single-layer, aqueous inkjet-receptive coating formulation is not without challenges, however. Modern ink-receptive coatings formulations often employ porous pigments (for example, calcium carbonate, silica, and so forth) to absorb the ink solvent and to provide a surface for the deposit of dye and/or pigment particles. The stable dispersion of these particles in water without undesirable sedimentation depends upon creating electrostatic repulsion (“zeta-potential”) between pigment particles. The addition of cationic materials directly to the coating formula, even in small quantities, can reduce the degree of repulsion between individual particles, resulting in an unstable composition that will sediment over time via agglomerative mechanisms.

Apart from these fabrication considerations and perhaps more interestingly, it has been found and is newly disclosed herein that the incorporation of certain ink fixatives or mordants directly into an ink-receptive coating composition accelerates fading of images printed when exposed to outdoor conditions (for example, UV and water exposure). So, while these mordants are on one hand required for achieving a wide spectrum of ink-receptiveness and color vibrancy, particularly among dye-based inks, they seemingly also result in poor exterior performance and longevity of the printed article.

It is believed that creators of custom, full-color signage for outdoor use may be more concerned with the cost and frequency of signage replacement than merely the initial the color vibrancy of the printed signage. In this case, the sacrifice of print image density or limits on the types of ink that may be used for printing (i.e., pigment-based inks only) in exchange for outdoor durability may be acceptable and practical.

In view of the above, an inkjet-receptive coated substrate which inherently protects images printed with pigment-based inkjet inks from fade due to UV or water exposure is of interest to the printing industry.

The present disclosure addresses the aforementioned issues by providing an inkjet-receptive coating composition and article for use with pigment-based inks which has improved outdoor durability and storage characteristics. It should be noted and appreciated that the use of mordants is required to create a water-fast image when using dye-based inks, as dyes are water-soluble. However, pigment-based inks pose no such requirement and produce inherently water-fast images when used with an appropriately coated substrate. Thus, by limiting the article such that it only may be printed on by a small number of ink compositions unlike known compositions which actually aim to accommodate a wide range of inks for a particular article, it can be possible to reduce the amount of mordant in the coating which, surprisingly and unexpectedly has been also been found to improve outdoor durability and color fade resistance. Accordingly, a calculated tradeoff may be made in closed systems in which the exact article to be printed upon and ink to be used for printing are known and prescribed. The outdoor durability and color fade resistance may be enhanced at the cost of greater compatibility with other inks (particularly dye-based inks), which tradeoff may be perfectly acceptable and perhaps not much of a tradeoff at all when the limitations of the ink to be used on the coating/coated article are known and taken into account during use.

According to one aspect, an ink-receptive composition is provided for coating a substrate to provide outstanding outdoor durability and color fade resistance. The ink-receptive composition includes a polymeric binder comprising an ethylene-based polymer, a pigment, a light stabilizer package comprising UV-absorber and a light stabilizer, and a surfactant. Optionally, the ink-receptive composition may comprise a water-soluble polymer. Preferably, the composition is mordant free; however, if a mordant is present at all, then the mordant is present in an amount less than 5 weight percent of the composition and more preferably less than 3 weight percent which is well below the amount of mordant found in other ink-receptive compositions.

In some forms of the ink-receptive composition, the ethylene-based polymer may be an ethylene-vinyl acetate polymer.

In some forms and if there is a water-soluble polymer, the water-soluble polymer of the ink-receptive composition may be a polyvinyl alcohol. More specifically and for example, the polyvinyl alcohol may be a hydrolyzed or fully hydrolyzed polyvinyl alcohol.

In some forms, the ethylene-based polymer of the ink-receptive composition may be emulsified with the water-soluble polymer to form an ethylene-based emulsion polymer.

In some forms, the ink-receptive composition may have a weight ratio of the ethylene-based polymer and the water-soluble polymer from 1:1 to 20:1.

In some forms, the ink-receptive composition may comprise from 10% to 90% of the polymeric binder, based on the dry weight of the composition.

In some forms, the pigment of the ink-receptive composition may be selected from the group consisting of carbonate, kaolin, silica, titanium dioxide, silicates, and combinations thereof.

In some forms, the pigment of the ink-receptive composition may have a uniform particle size distribution.

In some forms, the pigment of the ink-receptive composition may have a specific surface area from 150 m²/g to 400 m²/g, as measured in accordance with ASTM C 1274-12.

In some forms, the pigment of the ink-receptive composition may have a mean particle size from 1 to 10 microns, as measured in accordance with ASTM E2651-13.

In some forms, the ink-receptive composition may comprise from 5% to 70% of the pigment, based on the dry weight of the composition.

In some forms, the UV-absorber of the ink-receptive composition may be selected from the group consisting of benzophenone derivatives, benzotriazoles, triazines, oxalanilides, and combinations thereof.

In some forms, the light stabilizer of the ink-receptive composition may be selected from the group consisting of hindered phenols, hindered amines, and combination thereof.

In some forms, the ink-receptive composition may comprise from 0.01% to 10% of the light stabilizer package, based on the dry weight of the composition.

In some forms, the surfactant of ink-receptive composition may be selected from the group consisting of anionic surfactant, cationic surfactant, amphoteric surfactant, non-ionic surfactant, and combinations thereof.

In some forms, the ink-receptive composition may comprise from 0.01-10% of the surfactant, based on the dry weight of the composition.

In some forms, the optionally-present mordant of the ink-receptive composition may be water soluble.

In some forms and as noted above, the ink-receptive composition may comprise less than 3% of mordant, based on the dry weight of the composition.

In some forms, the ink-receptive composition may comprise less than 1% of mordant, based on the dry weight of the composition.

In some forms, the ink-receptive composition may be free of mordant.

In some forms, after 700 hours of accelerated weathering, the ink-receptive composition may have a change in yellow color density of less than 25%, compared to the original yellow color density.

According to another aspect, a method of making an article including a coating of such compositions is provided. The method includes applying an ink-receptive composition of the types and variants described herein and/or above to a first surface of a substrate to provide a coating on the substrate.

In some forms, the method may further include heating the substrate to cure the coating on the article.

In some forms, the method may further include applying an adhesive with a release liner to a second surface of the substrate, with the second surface being opposite to the first surface.

In some forms, the applying step of the method may be selected from the group consisting of covering, coating, wire wound rod, reverse roll, slot die, gravure, spraying, dipping, and combinations thereof.

According to yet another aspect, a method of printing with a pigment-based ink onto a coated polymeric substrate with an ink-receptive coating composition is provided. Again, the coated polymeric substrate is a substrate that has had a coating of the compositions described above and herein applied to it. The method includes applying the pigment-based ink to the coated polymeric substrate to print on the ink-receptive coating composition.

According to still another aspect, an article is provided for printing using pigmented ink that is outdoor durable. The article includes a substrate having a coating applied on one or more surfaces thereof in which the coating has an ink-receptive coating composition as described above and herein.

In some forms, the substrate of the article may be a polymeric substrate.

In some forms, the polymeric substrate of the article may include a material selected from a group consisting of polyester, polyolefin, polyimide, polycarbonate, acrylic, and vinyl.

In some forms, the polymeric substrate of the article may have on a surface opposite the surface receiving the coating that has an adhesive received thereon. The adhesive of the article may be covered by a release liner that is separable from the adhesive to expose the adhesive for attachment of the article to an object. This for example, can provide a printable adhesive label-like structure.

In some forms, the substrate may be a woven or non-woven fabric having the coating applied to it.

According to still another aspect, the present disclosure provides an aqueous, ink-receptive coating formulations and methods. In some forms, the present disclosure provides a combination(s) of raw materials to produce a liquid coating formulation which, when cast onto a polymeric substrate and dried, yields a durable coating which can accept aqueous, pigment-based inkjet inks.

According to still another aspect, the present disclosure relates to the use of such coated polymeric substrates in small-format inkjet printers to produce signage and labels that are resistant to fading when exposed to outdoor conditions.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### DESCRIPTION OF THE DRAWINGS

FIG. 1 is a schematic view of an article including a polymeric substrate coated with an ink-receptive composition having outstanding outdoor durability and color fade resistance in which the article has been printed upon and further includes an adhesive layer with the release liner still attached.

FIG. 2 is a schematic view of an article similar to the article of FIG. 1 including a polymeric substrate coated with an ink-receptive composition having outstanding outdoor durability and color fade resistance in which the article has been printed upon, but in which there is no adhesive or liner layers opposite the coated side of the substrate.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, a “binder” refers to a polymeric material of varying composition that holds a filler or pigment within a matrix.

As used herein, an “ethylene-based polymer” and like terms refer to a polymer containing, in polymerized form, a majority weight percent of units derived from ethylene based on the total weight of the polymer. Non-limiting examples of ethylene-based polymers include low density polyethylene (LDPE), linear low density polyethylene (LLDPE), very low density polyethylene (VLDPE), ultra low density polyethylene (ULDPE), medium density polyethylene (MDPE), high density polyethylene (HDPE), and functionalized polyethylene, for example, ethylene vinyl acetate (EVA), ethylene ethyl acrylate (EEA), and the like.

As used herein, a “pigment” is a visible light absorbing, scattering, refracting, or reflecting material or compound that is present in a non-molecularly dispersed (particulate) form.

As used herein, a “light stabilizer package” is a group of chemical compounds that are capable of protecting or stabilizing the substances against the harmful effects of light by transforming the harmful light into other kinds of energies.

As used herein, a “mordant” is a substance used to set dyes on a substrate by forming a coordination complex with the dye, which then attaches to the substrate.

The present disclosure relates to an article comprising composition for an inkjet-receptive coating and coated substrate (media). In some forms, the article may comprise a polymeric substrate coated with an ink-receiving layer which is resistant to fading under outdoor conditions. The polymeric substrate may be prepared from a wide variety of polymers including, but not limited to, polyester, polyolefin, polyimide, polycarbonate, acrylic, and vinyl. Preferably, the substrate is prepared from either a polyester or vinyl, particularly a polyethylene terephthalate (PET) ester or a vinyl chloride (PVC). Most preferably, the substrate is prepared from a vinyl chloride. The substrate is typically in the form of a film with a typical thickness of about 0.001 inches, about 0.002 inches, about 0.004 inches, about 0.006 inches, about 0.008 inches, about 0.010 inches, about 0.012 inches, or between about 0.001 and about 0.012 inches, or between about 0.002 and about 0.010 inches, or between about 0.003 and about 0.007 inches, or between about 0.004 and about 0.06 inches.

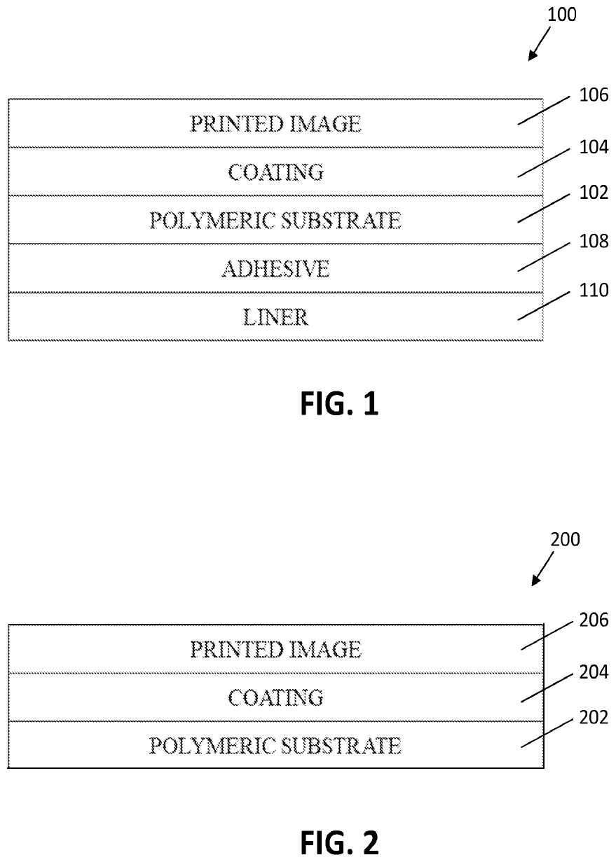

FIG. 1 depicts a schematic drawing of an article 100 including a polymeric substrate 102 which has an ink-receptive coating layer 14 on one side thereof. Although it is not initially part of the article 100, a print layer 106 can be printed on top of the coating layer 14 to present indicia such as text and/or images. It is noted that although this print layer 106 is depicted as a separate layer from the coating layer 104, in actuality, the ink from the printing process will enter the coating layer 104 and so the layers 104 and 106 are not as discrete as they appear in the schematic and, in fact, are for the most part overlapping. In the particular article 100 illustrated, on the side of the polymeric substrate 102 opposite the coating layer 104, the polymeric substrate 102 supports an adhesive layer 108 which is initially covered by a release liner 110. In use, the liner 110 may be removed to expose the adhesive layer 108 and the adhesive layer 108 may be used to affix the article to a surface.

In general application, the article 100 could be, for example, an outdoor-durable sign or label that has been printed on with pigment based ink to form the print layer 106. The article 100 may be printed on using a small-format inkjet printer (although is not necessarily so limited to that specific type of printing, but is well adapted for it).

Turning now to FIG. 2, FIG. 2 depicts a schematic of an article 200 with a polymeric substrate 202 and a coating layer 204 similar to FIG. 1, but without an adhesive layer and liner layer. This is effectively an alternative or variation to the general schematic view of FIG. 1. Even though a print layer 206 is depicted in the schematic, the article 200 does not initially have the print layer 206 (until after printing) and may just be the polymeric substrate 202 and coating layer 204. It is contemplated in some forms that the substrate 202 could be, but is not so limited to, woven or non-woven fabrics.

While two example articles have been illustrated, it will be appreciated that these are only exemplary and variations could be made. For example, not all of the surfaces of the substrate need to be coated with the coating layer and/or the adhesive (if an adhesive is indeed present) and only fractional portions of the surfaces might be covered. Moreover, nothing specifically requires that the coating layer and/or adhesive to be on one side or to be on opposite sides from one another. It will be readily appreciated that both sides may have the ink-receptive coating layer and/or the application of that coating layer to a side may be fractional or partial in nature. The same is likewise true for the adhesive layer and/liner. In this way, it is contemplated that various, more complex structures could be formed such as articles, which may be two-side printed and/or articles in which loops or other structures may be formed for attachment to objects.

Now, with some general exemplary structures having been described, some of the exemplary compositions of the various layers will be described in greater detail.

The composition of the adhesive—if an adhesive is present—can vary widely and includes, but is not limited to, materials comprising acrylic, rubber hybrid acrylic, and rubber pressure sensitive adhesives. Thermosetting polyester or polyurethane adhesives may be used. In some forms, the adhesive may be a pressure sensitive adhesive (PSA). The thickness of the adhesive layer may be in the range of about 0.0005 inches, about 0.0007 inches, about 0.0009 inches, about 0.0012 inches, about 0.0015 inches, about 0.002 inches, about 0.0025 inches, about 0.003 inches, or between about 0.0005 to about 0.003 inches, between about 0.0007 inches to about 0.0025 inches, between about 0.0009 inches to about 0.002 inches. As noted above, the adhesive layer may provide a way of fastening the inkjet-receptive article to the surface of another object or, in some cases, to itself to form a loop or other shape.

If an adhesive layer is present in the article, the bottom of the adhesive layer may be in contact with or covered by the release liner. The composition of the release liner can vary widely, and is typically silicone coated to protect the adhesive until it is applied to another object, and to carry the label through a printer. Non-limiting examples of the release liner can be a film type or a coated paper, which gives the adhesive a smooth surface which minimizes entrapped air when bonded to the end-use surface. The release liner may be optional to the overall construction and may be absent in embodiments in which no adhesive layer is present. However, in cases in which the article is being printed upon and fed through a printer, the initial covering of any adhesive by a liner will permit the article to be fed through the printer without sticking to rollers, example.

With respect to the ink-receptive coating layer, the composition of the coating comprises an ethylene-based polymer and, in some forms, may further comprise a water-soluble polymer. While the water-soluble polymer may be optional, the addition of the water-soluble polymer may benefit the abrasion resistance and the cohesive strength of the article and so is preferable in most cases. In some forms, the ethylene-based polymer can be an ethylene-vinyl acetate emulsion (EVA) polymer. In some forms, the water-soluble polymer can be a polyvinyl alcohol (PVA) solution polymer. The EVA may impart water fastness and UV resistance to the coating layer, while the PVA may increase the abrasion resistance and cohesive strength of the coating layer. Without wishing to be bounded by theory, as compared to vinyl acetate polymers, ethylene-vinyl acetate emulsions may promote adhesion to difficult polymer substrates (for example, PET) via incorporation of alkyl subunits. In some forms, near complete (98-99%) hydrolysis of the PVA may be used to ensure water fastness of the coating layer.

Any EVA copolymer may be suitable for use in the composition of the coating. Optionally, the EVA backbone may be modified with functional groups, such as acrylamides, amides, or carboxylic acids to increase adhesion to difficult substrates. In some forms, EVA emulsions may use either polyvinyl alcohol or nonionic surfactant stabilization systems and may have glass transition temperatures (Tg) ranging from −40 to 20° C., or from −35 to 20° C., or from −30 to 20° C., or from −25 to 20° C., or from −40 to 25° C., or from −40 to 30° C., or from −40 to 35° C. In some forms, an EVA emulsion utilizes a co-stabilization system may be comprised of both PVA and nonionic stabilizers, and may have a Tg ranging from −20 to 0° C., or from −20 to −5° C., or from −20 to −10° C., or from −20 to −15° C., or from −15 to 0° C., or from −10 to 0° C., or from −5 to 0° C. Non-limiting examples of EVA suppliers include Celanese, DuPont (ELVAX), and Wacker Chemie (VINNOL, VINNAPAS).

PVA may be produced industrially by hydrolysis of polyvinyl acetate. Typical commercially-available grades of PVA may include partially hydrolyzed (88%), fully-hydrolyzed (98-99%), and super-hydrolyzed (cross-linked). PVA can also be characterized by degree of polymerization (molecular weight), with higher molecular weight grades imparting increased film strength at the expense of handling characteristics. PVA is commercially available from multiple suppliers, including Kuraray (ELVANOL, POVAL) and Sekisui (SELVOL). Both pellet and solution grades are offered. In some forms, a PVA is fully-hydrolyzed (98-99%) with an average molecular weight ranging from about 125,000 to about 200,000 g/mol, from about 135,000 to about 200,000 g/mol, from about 150,000 to about 200,000 g/mol, from about 175,000 to about 200,000 g/mol, or from about 125,000 to 175,000 g/mol, from about 125,000 to about 150,000 g/mol, from about 125,000 g/mol to about 135,000 g/mol.

Modifying the relative amounts of EVA and PVA in the coating formula may allow the end properties of the coating to be tailored to the application. In a non-limiting example, increasing the relative amount of EVA may yield greater water fastness at the expense of abrasion resistance and cohesive strength. In some forms, if PVA is included, the PVA:EVA ratio may range from about 1:1, about 1:2, about 1:4, about 1:6, about 1:8, about 1:10, about 1:12, about 1:14, about 1:16, about 1:18, about 1:20, or between about 1:1 to about 1:20, or between about 1:2 to about 1:15; or between about 1:4 to 1:10; or between about 1:6 to about 1:8, by dry weight. In some forms, a weight ratio of 1:4 to 1:10 may be preferred. The PVA and EVA mixture, when combined with a suitable pigment, may exhibit the following non-limiting properties such as resistance to abrasion and scratching, softness/flexibility, resistance to water, good adhesion to polymeric substrates, and high cohesive strength

The total amount of polymeric binder present in the inkjet-receptive coating may vary, but is typically in an amount about 10%, about 20%, about 35%, about 50%, about 75%, about 90%, or between about 10% to about 90%, between about 20% to about 90%, between about 35% to about 90%, between about 50% to about 90%, between about 75% to about 90%, or between about 10% to about 75%, between 10% to about 50%, between about 10% to about 35%, or between about 25% to 55%, by dry weight of the composition.

The inkjet-receptive coating further includes a pigment. For example, the pigment could be, but not is limited to, one or more of calcium carbonate, kaolin, silica, titanium dioxide, or various silicates. A narrow particle size distribution may be a more important selection criterion for the pigment than is mean particle size. Coatings utilizing a pigment with a broad particle size distribution typically yield mottled (that is, non-uniform) printed images. In some forms, silica maybe a preferred pigment relative to other potential pigments due to the ability of manufacturers to tightly control its particle size distribution, surface area, and pore size distribution. Dispersions of silica may be easily created and stabilized by conventional methods. In some forms, of the various types of silica (colloidal, fumed, precipitated), precipitated grades may be preferred due to their extremely high porosity, which may aid in absorption and drying of the large quantities of ink that are deposited by modern inkjet printers. These silica pigments are commercially available from Evonik (SIPERNAT, SPHERILEX), Grace Davidson (SYLOID), and PPG (LO-VEL), among others. In some forms, the pigments used in practice may have a specific surface area of about 150 m²/g, about 200 m²/g, about 250 m²/g, about 300 m²/g, about 350 m²/g, about 400 m²/g, or between about 150 to about 400 m²/g, between about 200 to about 400 m²/g, between about 250 to about 400 m²/g, between about 300 to about 400 m²/g, between about 350 to about 400 m²/g, between about 150 to about 350 m²/g, between about 150 to about 300 m²/g, between about 150 to about 250 m²/g, between about 150 to about 200 m²/g, as measured by ASTM C 1274-12. In some forms, the pigments may have a mean particle size of about 1 microns, about 2 microns, about 6 microns, about 8 microns, about 10 microns, or between about 1 to about 10 micros, or between about 2 to about 8 microns, or between about 3 to about 7 microns, or between about 4 to about 6 microns, as measured by ASTM E2651-13. The amount of pigment in the formulation from which the coating is made can vary. In some forms, the pigment can be in an amount of about 5%, about 10%, about 15%, about 25%, about 50%, about 60%, about 70%, or between about 5% to about 70%, between about 15% to about 65%, between about 25% to about 55% by dry weight of the composition.

In some forms, the inkjet-receptive coating may also comprise a UV-absorber and a light stabilizer. Both components may be used to protect both the coating and the printed image from UV degradation in outdoor applications. Non-limiting examples of UV-absorbers include benzophenone derivatives, benzotriazoles, triazines, and oxalanilides. Non-limiting examples of suppliers of UV-absorbers include BASF (TINUVIN), Clariant (HOSTAVIN), Double Bond Chemical Ind., Co. (CHISORB), and SONGWON Industrial Group (SONGSORB). Non-limiting light stabilizers include hindered phenols and hindered amines. Non-limiting examples of suppliers of light stabilizers include BASF (CHIMASSORB, TINUVIN), Clariant (HOSTAVIN), Double Bond Chemical Ind., Co. (CHISORB), Mayzo, Inc. (BLS), and SONGWON Industrial Group (SONGSORB). In some forms, the amount of UV-absorber and light stabilizer in the inkjet-receptive coating may be about 0.01%, about 0.02%, about 0.05%, about 0.1%, about 0.5%, about 1%, about 2.5%, about 5%, about 7.5%, about 10%, or range from about 0.01% to about 10%, or from about 0.01% to about 7.5%, or from about 0.01% to 5%, by dry weight of the coating.

In some forms, the inkjet-receptive coating may also include a surface-active component (surfactant) as a processing aid. In some forms, the selection of the appropriate surfactant aids in foam release from the liquid coating formulation, which helps achieve a defect-free coating layer. In some forms, an appropriate surfactant may also aid in wetting of the polymeric substrate via reduction of the coating surface tension. Surfactants may be classed according to the composition of the hydrophilic head group; classes include, but are not limited to: anionic, cationic, amphoteric, and non-ionic. In some forms, the surfactant may be a non-ionic surfactant. Non-limiting examples of surfactant can include fatty alcohol ethoxylates, alkylphenol ethoxylates, fatty acid ethoxylates, ethoxylated amines, fatty acid amides, and sorbitol derivatives. Specialty non-ionic surfactants may include hydrophobic silica or fluorocarbons. Non-limiting examples of suppliers of preferred non-ionic surfactants include SILWET (Momentive Performance Materials), SURFADONE (Ashland), and SURFYNOL (Evonik). In some forms, the amount of surfactant in the coating may vary, but may be in the amount of about 0.01%, about 0.05%, about 0.1%, about 0.5%, about 1%, about 2%, about 5%, about 7.5%, about 10%, or in the range between about 0.01% to about 10%, about 0.02% to about 7.5%, or about 0.05% to about 5%, based on the total weight of solids in the formulation from which the coating is made.

Notably, the coating composition should be mordant free or, if mordant is present at all, only include a very small amount of mordant (that is less than the 5 wt % by total composition which is less than known mordant-bearing coatings). The use of mordant as a dye fixer is well known in the art and it is heretofore believed unknown to exclude mordant or to include extremely small amounts of mordant in coating compositions of the types described herein. In general, the increasing amount of mordant was believed to lead to deep and vibrant color of inkjet printed images and to increase the compatibility of the article with a wide range of ink types, as different ink compositions may be more or less receptive on a particular article and increased amounts of mordant generally opened up the number and types of inks that could be used for printing. However, contrary to this conventional paradigm, this disclosure indicates that the use of mordant should be minimized, if not avoided outright preferably. Without wishing to be bounded by theory, the inventors have surprisingly discovered that by removing mordant altogether or extremely minimizing the amount of mordant in the composition of the coating, outdoor durability and color fade performance can be drastically improved. To improve outdoor durability and storage characteristics of inkjet printed images, the present coating composition may comprise less than 5% of mordant, less than 4% of mordant, or less than 3% of mordant, less than 2.5% of mordant, less than 2% of mordant, less than 1.5% of mordant, less than 1% of mordant, less than 0.5% of mordant based on the dry weight of the composition. In some forms, the composition is completely free of mordant or would include only trace levels of mordant. While various limits on mordant are presented above, further work is being done to establish the exact point of drop off in outdoor durability, although it is anticipated from present data that outdoor durability and fade resistance may begin to change appreciably at around 3% of mordant by dry weight (with worse properties being exhibited at greater amounts or mordant).

In some forms, the facial surface of the inkjet-receptive coating may be in contact with the facial surface of the print layer to the extent that the print layer is not already integrated with or received the coating layer. The composition of the printing layer may be aqueous pigment ink, that is a water-based ink comprising pigments, one or more polymers, and one or more additives, all of which cure into a film upon drying. Aqueous pigment-based inks are widely available commercially; representative non-limiting examples of suppliers include Funai, HP, Kodak, and Ricoh. In some forms, the graphics layer may be applied to the inkjet-receptive coating layer by way of a small-format inkjet printer. Small-format inkjet printers typically cannot print media larger than about 10 inches and are suitably equipped to deliver aqueous inks.

In some forms, the media may be prepared in a manner similar to media described in the art. In one non-limiting exemplary method, the polymeric substrate may be first prepared in any conventional manner, e.g. as a film cast or extruded, in one or more multiple layers from one or more polymeric resins, e.g. vinyl chloride (PVC). The substrates may be typically commercially-available films. The film may be then covered or coated with the printable coating on one facial side, for example. The coating formulation can be applied to the media in any manner, e.g. wire wound rod, reverse roll, slot die, gravure, spraying, dipping, and so forth, and application of the coating is usually, but not necessarily followed by a heat drying/curing process, e.g. exposure to a temperature of about 50° C., about 75° C., about 100° C., about 150° C., about 200° C., or between about 50° C. to about 200° C., between about 100° C. to about 150° C. Exposure time can range between about 1 minutes to 10 minutes, or about 2 minutes to 8 minutes; or about 4 minute to 6 minutes, depending on the type of substrate and the desired performance of the coated media such as chemical/solvent resistance, scratch/abrasion resistance, durability, etc. The coating formulation is typically applied at a thickness of about 5 micrometers, about 10 micrometers, about 20 micrometers, about 25 micrometers, about 30 micrometers, about 40 micrometers, about 50 micrometers, about 100 micrometers, about 150 micrometers, about 200 micrometers, or between about 5 micrometers to about 200 micrometers, between about 10 micrometers to about 100 micrometers, or between about 20 micrometers to about 50 micrometers. In some forms, the coating formulation may typically be applied in a layered structure. In some forms, the coating formulation may be applied as a single layer. In some forms, the coating formulation may be applied as more than one layers.

In some forms, after the coating is dried, an adhesive may be applied in any conventional manner to the opposite facial surface of the film. The liner may then be applied to the exposed surface of the adhesive layer. If the media does not comprise an adhesive, then these two steps may be eliminated. Many variations exist on this illustrative method of preparing the label construction. In a non-limiting example, the two or more of the described steps can be reversed or otherwise changed in sequence.

In some forms, any forms of indicia maybe printed onto the ink-receptive coating. Non-limiting examples include texts, characters, forms, signage, visual graphics, pictures, photos, and lines.

### EXAMPLES

The following examples set forth, in detail, ways in which articles of the kind described herein may be created, used, and implemented, and assist to enable one of skill in the art to more readily understand the principles thereof. The following examples are presented by way of illustration and are not meant to be limiting in any way.

The invention may be understood in greater detail by the following illustrative examples. All percentages given in the examples are by weight unless otherwise specified. The raw materials used for the following examples are commercially available and are described below:
Cab-O-Sperse® PG022—aqueous cationic fumed silica dispersion from Cabot Corporation of Billerica, Mass.
Cetyltrimethylammonium chloride (HDTMAC), 25% solution—cationic surfactant solution available from Sigma-Aldrich Inc. of St. Louis, Mo.
Leucophor® FTS—cationic optical brightener available from Archroma U.S. Inc. of Charlotte, N.C.
PrintRitem DP-336A—aqueous, matte inkjet-receptive coating formulation available from The Lubrizol Corporation of Brecksville, Ohio
Poly(diallydimethylammonium chloride), 35% solution—very low-molecular weight solution of pDADMAC mordant available from Sigma-Aldrich Inc. of St. Louis, Mo.
Selvol™ 09-325—solution-grade fully-hydrolyzed polyvinyl alcohol, 8.5% solids from Sekisui Specialty Chemicals America of Dallas, Tex.
Sipernat® 350—anhydrous amorphous silica from North America Evonik Corporation of Parsippany, N.J.
Surfynol® 104PA—non-ionic, multifunctional gemini defoamer available from North America Evonik Corporation of Parsippany, N.J.
Surfynol® DF-58—non-ionic, polyether siloxane defoamer available from North America Evonik Corporation of Parsippany, N.J.
Syloid® W-300—hydrated amorphous silica from W.R. Grace, Baltimore, Md.
Tinuvin® 123-DW (N)—aqueous N-OR hindered-amine light stabilizer (HALS) from BASF Corporation of Florham Park, N.J.
Tinuvin® 479-DW (N)—aqueous HPT UV-absorber from BASF Corporation of Florham Park, N.J.
Vinnapas® EP7000—high-solids ethylene-vinyl acetate emulsion polymer from Wacker Chemical Corporation of Adrian, Mich.

### Example 1

| | |
|---|---|
| Deionized water | 24.68 |
| Surfynol ® 104PA | 0.11 |
| Syloid ® W-300 | 32.37 |
| Vinnapas ® EP7000 | 19.69 |
| Selvol ™ 09-325 | 17.47 |
| Tinuvin ® 479-DW (N) | 3.84 |
| Tinuvin ® 123-DW (N) | 1.03 |
| Ammonium hydroxide, 27% solution | 0.80 |
| Totals | 100.00 |

The mixture of Example 1 was prepared by dispersing the Syloid® W-300 silica and Surfynol® 104PA in deionized water using a high-shear cowles blade for about 20 minutes. The final five components (ammonium hydroxide, Selvol™ 09-325, Tinuvin® 123-DW (N), Tinuvin® 479-DW (N), and Vinnapas® EP7000) were added and stirred under low agitation for approximately 5 minutes.

The mixture was then coated onto 2 mil white PET (Melinex® 329, DuPont) using a knife-over-roll coater with a 5 mil gap and dried in a forced-air oven at about 225° F. to achieve a dry coating weight of about 5 lb/MSF. A full-color test pattern was then printed on the sample material using a BradyJet J2000 small-format inkjet printer with standard print settings of 78% Q3. The inks used were Brady J20 CMY inks with a composite (C+M+Y) black.

The print was allowed to air dry for 24 hours. Initial print density and color measurements were collected using an X-Rite eXact™ spectrodensitometer. The sample was then subjected to approximately 700 hours of accelerated aging in an Atlas Ci5000 Weather-Ometer® set to ASTM G-155 Cycle 1. After aging, the print density and color measurements were repeated. To evaluate dye ink performance (water fastness), a full-color test pattern was printed using a BradyJet J2000 small-format inkjet printer with standard print settings of 78% Q3 and a dye ink set. The pattern was allowed to equilibrate overnight, and then immersed for 24 hours in DI water. Print density and color were measured before and after immersion. Results are presented in Table 1 following the other examples.

### Example 2

| | |
|---|---|
| Deionized water | 46.01 |
| Surfynol ® 104PA | 0.40 |
| Surfynol ® DF-58 | 0.20 |
| Sipernat ® 350 | 14.30 |
| Vinnapas ® EP7000 | 18.31 |
| Selvol ™ 09-325 | 16.25 |
| Tinuvin ® 479-DW (N) | 3.57 |
| Tinuvin ® 123-DW (N) | 0.96 |
| Totals | 100.00 |

The mixture of Example 2 was prepared in the same manner as described in Example 1. The mixture was then coated onto 3.2 mil white vinyl (B-595, Brady Corporation) using a knife-over-roll coater with a 5 mil gap and dried in a forced-air oven at about 225° F. to achieve a dry coating weight of about 5 lb/MSF. The printing and testing were described in the same manner as Example 1. The results are presented in Table 1 following the description of the other examples.

### Example 3

| | |
|---|---|
| Deionized water | 32.40 |
| Surfynol ® 104PA | 0.11 |
| Syloid ® W-300 | 19.22 |
| pDADMAC, 35% solution | 2.00 |
| Cab-O-Sperse ® PG022 | 2.30 |
| HCl, 10% solution | 0.85 |
| Vinnapas ® EP7000 | 18.24 |
| Selvol ™ 09-325 | 16.07 |
| DI water | 8.01 |
| HCl, 10% solution | 0.80 |
| Totals | 100.00 |

The mixture of Example 3 was prepared by dispersing the Syloid® W-300 silica, Surfynol® 104PA, 35% pDADMAC solution, Cab-O-Sperse® PG022, and 10% HCl solution in deionized water using a high-shear cowles blade for about 20 minutes. The final four components (10% HCl solution, Selvol™ 09-325, Vinnapas® EP7000, DI water) were added and stirred under low agitation for approximately 5 minutes. The coating, printing and testing were described in the same manner as Example 1. The results are presented in Table 1 following the description of the other examples.

### Comparative Example 1

| | |
|---|---|
| Deionized water | 38.68 |
| pDADMAC, 35% solution | 9.25 |
| Syloid ® W-300 | 29.64 |
| Vinnapas ® EP7000 | 20.88 |
| HDTMAC, 25% solution | 1.10 |
| Leucophor ® FTS | 0.46 |
| Totals | 100.00 |

The mixture of Comparative Example 1 was prepared by dispersing the Syloid® W-300 silica and pDADMAC solution in deionized water using a high-shear cowles blade for about 20 minutes. The final three components (HDTMAC, Leucophor® FTS, and Vinnapas® EP7000) were added and stirred under low agitation for approximately 5 minutes.

The mixture was then coated onto 2 mil white PET (Melinex® 329, DuPont) using a Cheminstruments laboratory drawdown machine with a 5 mil gap and dried in a forced-air oven at about 300° F. to achieve a dry coating weight of about 5 lb/MSF. Printing and testing were performed as described in Example 1. The results are presented in Table 1 following the description of the other examples.

### Comparative Example 2

A liquid sample of PrintRitem DP-336A from the Lubrizol Corporation was coated onto 2 mil white PET (Melinex® 329, DuPont) using a knife-over-roll coater with a 5 mil gap and dried in a forced-air oven at about 225° F. to achieve a dry coating weight of about 5 lb/MSF. Printing and testing were performed as described in Example 1. The results are presented in Table 1.

TABLE 1

| | | Accelerated | | Water |
|---|---|---|---|---|
| | Initial | weathering, | Final | fastness, |
| Sample | density | Fade (Delta E) | density | dye ink |
| Example 1 | Cyan - 0.54 | Cyan - 9.11 | Cyan - 0.44 | Poor |
| | Magenta - 0.72 | Magenta - 9.53 | Magenta - 0.61 | |
| | Yellow - 0.81 | Yellow - 15.08 | Yellow - 0.64 | |
| | Black - 0.73 | Black - 14.45 | Black - 0.55 | |
| Example 2 | Cyan - 0.77 | Cyan - 6.02 | Cyan - 0.71 | Poor |
| | Magenta - 0.87 | Magenta - 13.56 | Magenta - 0.80 | |
| | Yellow - 0.89 | Yellow - 4.49 | Yellow - 0.86 | |
| | Black - 0.77 | Black - 8.05 | Black - 0.70 | |
| Example 3 | Cyan - 0.70 | Cyan - 11.38 | Cyan - 0.52 | Good |
| | Magenta - 0.93 | Magenta - 15.98 | Magenta - 0.73 | |
| | Yellow - 0.91 | Yellow - 22.17 | Yellow - 0.68 | |
| | Black - 0.91 | Black - 12.90 | Black - 0.75 | |
| Comp. | Cyan - 0.68 | Cyan - 13.34 | Cyan - 0.50 | Good |
| Example 1 | Magenta - 0.80 | Magenta - 27.04 | Magenta - 0.52 | |
| | Yellow - 0.86 | Yellow - 67.75 | Yellow - 0.20 | |
| | Black - 0.83 | Black - 32.48 | Black - 0.61 | |
| Comp. | Cyan - 0.76 | Cyan - 22.62 | Cyan - 0.45 | Good |
| Example 2 | Magenta - 0.89 | Magenta - 36.53 | Magenta - 0.49 | |
| | Yellow - 0.91 | Yellow - 59.01 | Yellow - 0.39 | |
| | Black - 0.88 | Black - 27.09 | Black - 0.54 | |

The results of Table 1 demonstrate the improved fade performance of the disclosed coating compositions with respect to the comparative examples. In general, the color densities of images printed upon the media of the newly disclosed compositions are greater after 700 hours of accelerated weathering, with the magenta and yellow colors demonstrating the greatest degree of improvement. Specifically, after 700 hours of accelerated weathering, Example 1 has a change in yellow color density of 21% comparing to the original yellow color density; Example 2 has a change in yellow color density of 3% comparing to the original yellow color density; and Example 3 has a change in yellow color density of 25% comparing to the original yellow color density. The Comparative Examples all exhibit much greater change in yellow color density when comparing to the original yellow color density, after 700 hours of accelerated weathering. Comparative Example 1 and 2 have a change in yellow color density of 77% and 57%, respectively. Table 1 also demonstrates why pigment-based inks should be used with these new coating compositions, as water fastness for dye inks was poor. As mentioned above in the summary section, compatibility with dye-based inks has been sacrificed in favor of extended outdoor durability and color fade resistance. However, in “closed systems” where it can be assured that a pigment-based ink of a particular kind can be used with a corresponding substrate, the potential negative of compatibility with a wide range of inks is negated.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

Various features and advantages of the invention are set forth in the following claims.

We claim:

1. An ink-receptive composition for coating a substrate to provide outstanding outdoor durability and color fade resistance, the composition comprising:
a polymeric binder comprising an ethylene-based polymer;
a pigment;
a light stabilizer package comprising UV-absorber and a light stabilizer;
a surfactant; and
optionally, a mordant in an amount less than 5 weight percent of the composition.

2. The composition of claim 1, wherein the ethylene-based polymer is an ethylene-vinyl acetate polymer.

3. The composition of claim 1, wherein the polymeric binder further comprising a water-soluble polymer.

4. The composition of claim 3, wherein the water-soluble polymer is a polyvinyl alcohol.

5. The composition of claim 4, wherein the polyvinyl alcohol is a hydrolyzed polyvinyl alcohol.

6. The composition of claim 4, wherein the polyvinyl alcohol is a fully hydrolyzed polyvinyl alcohol.

7. The composition of claim 3, wherein the ethylene-based polymer is emulsified with the water-soluble polymer to form an ethylene-based emulsion polymer.

8. The composition of claim 3, wherein the weight ratio of the ethylene-based polymer and the water-soluble polymer is from 1:1 to 20:1.

9. The composition of claim 1, wherein the composition comprises from 10% to 90% of the polymeric binder, based on the dry weight of the composition.

10. The composition of claim 1, wherein the pigment is selected from the group consisting of carbonate, kaolin, silica, titanium dioxide, silicates, and combinations thereof.

11. The composition of claim 1, wherein the pigment has a uniform particle size distribution.

12. The composition of claim 1, wherein the pigment has a specific surface area from 150 m²/g to 400 m²/g, as measured in accordance with ASTM C 1274-12.

13. The composition of claim 1, wherein the pigment has a mean particle size from 1 to 10 microns, as measured in accordance with ASTM E2651-13.

14. The composition of claim 1, wherein the composition comprises from 5% to 70% of the pigment, based on the dry weight of the composition.

15. The composition of claim 1, wherein the UV-absorber is selected from the group consisting of: benzophenone derivatives, benzotriazoles, triazines, oxalanilides, and combinations thereof.

16. The composition of claim 1, wherein the light stabilizer is selected from the group consisting of hindered phenols, hindered amines, and combination thereof.

17. The composition of claim 1, wherein the composition comprises from 0.01% to 10% of the light stabilizer package, based on the dry weight of the composition.

18. The composition of claim 1, wherein the surfactant is selected from the group consisting of: anionic surfactant, cationic surfactant, amphoteric surfactant, non-ionic surfactant, and combinations thereof.

19. The composition of claim 1, wherein the composition comprises from 0.01-10% of the surfactant, based on the dry weight of the composition.

20. The composition of claim 1, wherein the mordant is water soluble.

21. The composition of claim 1, wherein the composition comprises less than 3% of mordant, based on the dry weight of the composition.

22. The composition of claim 1, wherein the composition comprises less than 1% of mordant, based on the dry weight of the composition.

23. The composition of claim 1, wherein the composition is free of mordant.

24. The composition of claim 1, wherein after 700 hours of accelerated weathering, the composition has a change in yellow color density of less than 25%, compared to the original yellow color density.

25. A method of making an article, the method comprising:
applying the composition of claim 1 to a first surface of a substrate to provide a coating on the substrate.

26. The method of claim 25 further comprising:
heating the substrate to cure the coating on the article.

27. The method of claim 25 further comprising:
applying an adhesive with a release liner to a second surface of the substrate;
wherein the second surface is opposite to the first surface.

28. The method of claim 25, wherein the applying step is selected from the group consisting of: covering, coating, wire wound rod, reverse roll, slot die, gravure, spraying, dipping, and combinations thereof.

29. A method of printing with a pigment-based ink onto a coated polymeric substrate in which the composition of claim 1 provides a coating on a substrate, the method comprising:
applying the pigment-based ink to the coated polymeric substrate to print on the coating.

30. An article for printing using pigmented ink that is outdoor durable comprising a substrate having a coating applied on a surface thereof, in which the coating has the composition of claim 1.

31. The article of claim 30, wherein the substrate is a polymeric substrate.

32. The article of claim 31, wherein the polymeric substrate includes a material selected from a group consisting of polyester, polyolefin, polyimide, polycarbonate, acrylic, and vinyl.

33. The article of claim 30, wherein the polymeric substrate has an adhesive received thereon on a surface opposite the surface receiving the coating.

34. The article of claim 33, wherein the adhesive is covered by a release liner that is separable from the adhesive to expose the adhesive for attachment of the article to an object.

35. The article of claim 30, wherein the substrate is a woven or non-woven fabric.
